(19) United States
(12) Patent Application Publication
(10) Pub. No.: US 2007/0271260 A1
(43) Pub. Date: Nov. 22, 2007

(54) Method and apparatus for rating the performance of a person and groups of persons

(76) Inventor: Vincent Paul Valentino, Copiague, NY (US)

Correspondence Address: PATENT DOCKET CLERK;COWAN, LIEBOWITZ & LATMAN, P.C., 1133 AVENUE OF THE AMERICAS, NEW YORK, NY, 10036, US

(21) Appl. No.: 11/801,797

(22) Filed: May 11, 2007

Related U.S. Application Data
(60) Provisional application No. 60/802,343, filed on May 22, 2006.

(51) Int. Cl. G06F 17/30

(52) U.S. Cl. 707/5

(57) ABSTRACT

There is disclosed a method implemented by a programmed computer determining the performance of at least one person to carry out at least one activity. Each activity comprises a plurality of tasks, including determining from a plurality of tasks at least one task to be performed by one person, and defining at least one set of criteria where each criteria determines how well the one person performs the corresponding task, and defining for each task a weight that determines the relative effectiveness of its criteria to enhance the performance of the activity. Next, a numerical rating is measured as to how well the activity corresponding to each of the plurality of criteria is being performed. Then, the numerical rating reference for each of the plurality of criteria is multiplied times the corresponding weight to provide a product related to the corresponding criteria, before summing the products related to each of the plurality of criteria to provide a total of the products of all of the criteria. Finally, the total of the products is divided by the sum of the weights to provide an overall rating that is reflective of the performance ranking of the one person to carry out the activity.

This application claims priority from Provisional Application Ser. No. 60/802,343 filed on May 22, 2006.

### RELATED APPLICATION

This application is related to U.S. Provisional Application Ser. No. 60/802,343 which is incorporated into this application by reference.

### FIELD OF INVENTION

This invention relates to a method and/or method of rating the performance of an individual, a company comprised of a plurality of individuals and/or a plurality of companies to accomplish a defined task.

### SUMMARY

Accordingly, it is an object of this invention to digitally reformat and process employee data from various systems, then to display this data and the employee's performance rating, whereby the client company can view the performance rating of its service companies and the managers of the service companies can view the performance rating and data that this rating is based on of its employees or managers.

It is one object of this invention to process this data and provide the user with a more accurate assessment of the significance of predefined subcriteria of an employee determined to impact sales for the client company.

It is a further object of this invention for the user to identify certain patterns of this data and actions taken based on these patterns for the training of the artificial intelligence of this system to recognize these patterns and their behavior in the future.

It is a still further object of this invention to display the data with the performance rating in various function formats such as on a map, table, report display with the ability to query the data.

It is another object of this invention to permit on line access to a website that is connected to the Internet, whereby the user may vary parameters such as time, subcriteria, function display formats, location and people to display the data input and processed data in the server.

In accordance with these and other objects of this invention, a method is disclosed of rating the performance of at least one person to carry out at least one activity. The activity comprises a plurality of tasks. The method comprises the following steps. First, at least one task from a plurality of tasks is determined to be performed by one person. Next, at least one set of criteria is defined, whereby each criteria determines how well the one person performs a corresponding task. Therefore, each task defines a weight that determines the relative effectiveness of its criteria to enhance the performance of the activity to achieve at least one task. Next, a numerical rating is measured that is reflective of how well the activity corresponding to each of the plurality of criteria is being performed. Thereafter, the measured rating reference for each of the plurality of criteria is multiplied times the corresponding weight to provide a product related to the corresponding criteria. Next, the products related to each of the plurality of criteria are summed to provide a total of the products of all of the criteria. Finally, the total of the products is divided by the sum of the weights to provide an overall rating that is reflective of the performance ranking of the one person to carry out the activity.

In a further aspect of this invention, there is provided a method of preparing a server to support a client system to reformat and process employee data for a performance rating system that can be displayed in various formats through a communication link and provides an informational database of identified patterns and their behaviors for forecasting sales.

### BRIEF DESCRIPTION OF THE DRAWINGS

FIG. 1 is a functional block diagram illustrating how a user's browser and a server of the website to be accessed by the user's browser are connected to by a communication link to each other. This block diagram also illustrates how the database server receives input from external systems.

FIGS. 2A-C are flow diagrams for the Performance Rating Process, which are loaded on the server system for the inputting and processing of subcriteria values to populate a performance rating value of the Performance Rating Overall (PRO) of an employee or group of employees.

FIGS. 3A and 3B are flow diagrams on the Criteria Correlation Process for Weight Assignment, which are loaded on the server system for search of relationship between subcriteria to populate a proposed weight for the subcriteria.

FIG. 4 is a flow diagram for the Pattern Correlation Process, which is loaded on the server system for search of patterns between subcriteria or employees to be recognized in the future.

FIG. 5 is a flow diagram which illustrates the process by which the user uses the browser to access the website and its server system as shown in FIG. 1.

FIGS. 6A-E are a series of sample web screens displayed for the user to view on his browser.

FIG. 7 shows the inheritance of each user in the system, wherein the general user is at the top of the illustrated tree with basic privileges and each user below that hierarchy has additional attributions to their profile.

### DETAILED DESCRIPTION OF A PREFERRED EMBODIMENT OF THE INVENTION

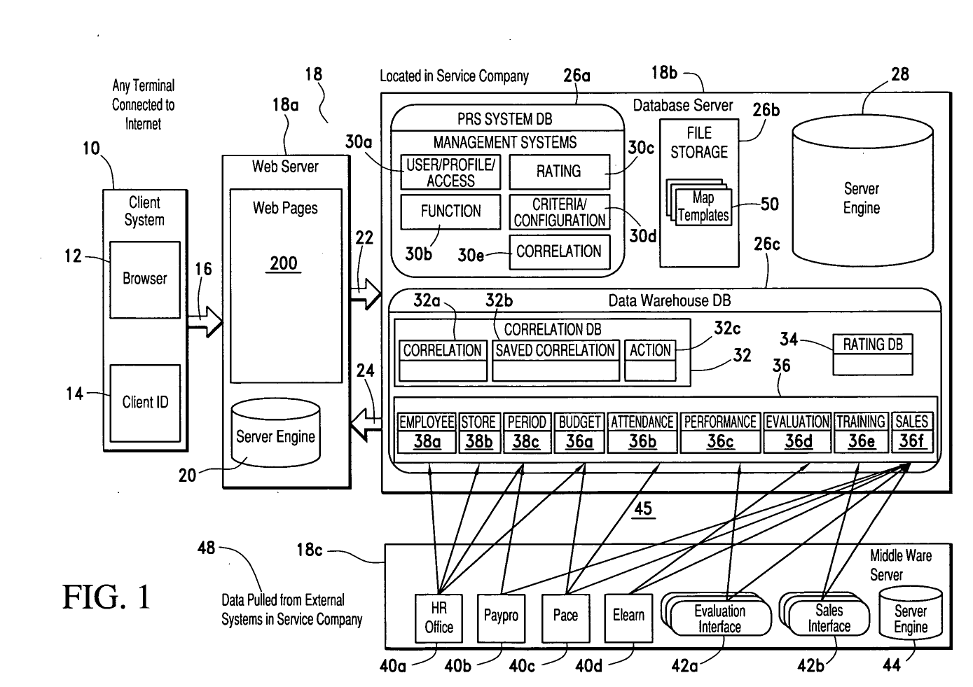

Referring now to the drawings and in particular to FIG. 1, there is shown an embodiment of this invention which permits the user, using his/her client system 10, to access a server system 18 by exchanging messages over a communication link 16 in the form of the internet. The client system 10 comprises a browser 12 and its assigned client identifier stored in a file 14, which is known as a “cookie”. Though only a single client system 10 is illustrated in FIG. 1, there would be a plurality of client systems 10, which are connected to the communication link 16 and capable of transmitting messages over the link 16 to the server system 18. The administrator initiates on the browser 12, a communication session with the session system 18 by assigning and sending over the link 16 the client identifier to the client system 18. From then on, the user includes the client identifier in the client system 10 with all messages sent to the server system 18 so that the server system 18 can identify the particular client system 10 from which the message was sent.

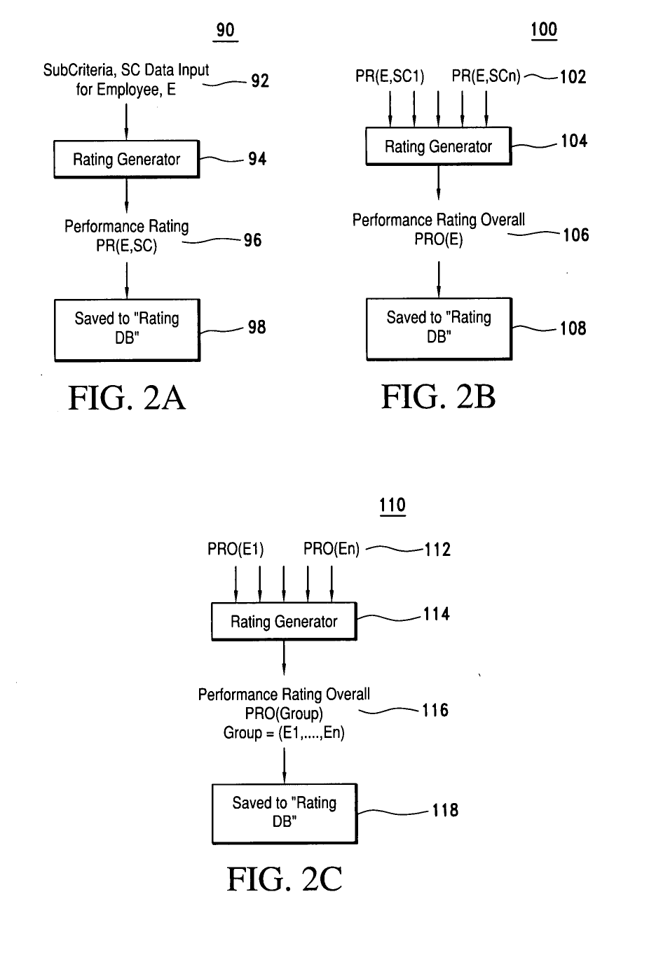

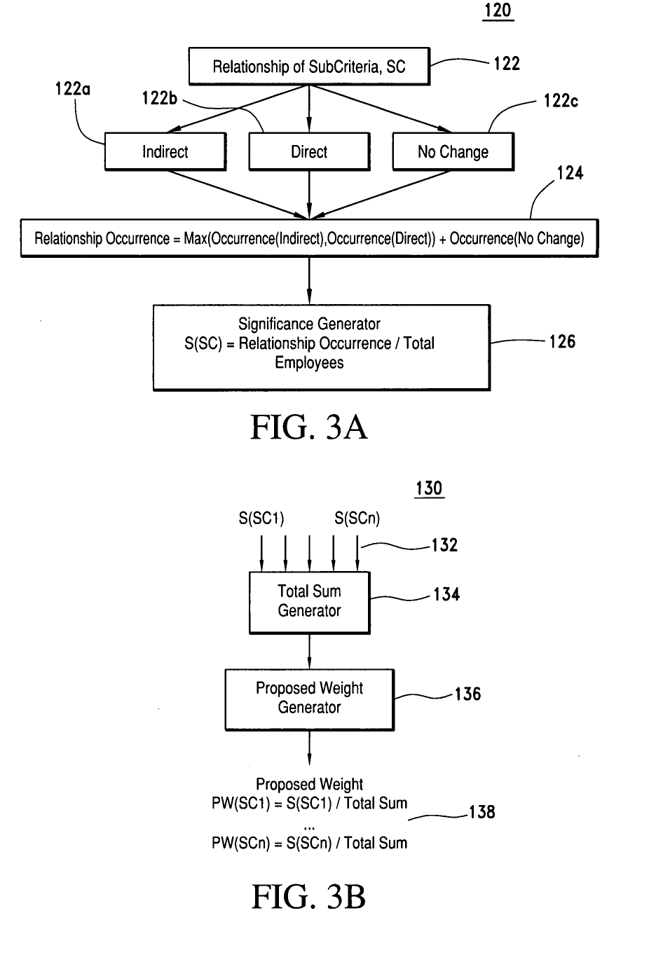

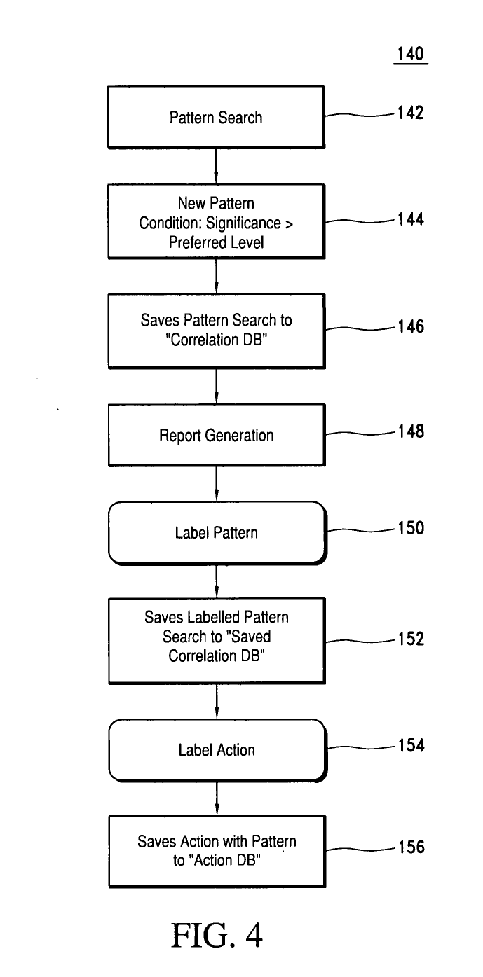

The server system 18 comprises, as shown in FIG. 1, a web server 18a, a database server 18b for data used by the system, and a middleware server 18c as a depository server for the system. The server system 18 is front ended, as described above, in that the user can access the system 18 by sending requests from the browser 12 via the communication link 16 to the web server 18a. Data is back ended and is received by the middle ware server 18c from external systems of the company 48. The Middle Ware Server 18c then restructures and formats this data 44 into the criteria database 36 of the database server 18b. The database server 18b comprises of the system database 26a for system management data, file storage for map templates 26b, and the data warehouse database 26c for data used by the system. The processes of the database server 28 are illustrated through flow diagrams shown in FIGS. 2A-C, FIGS. 3A-B and FIG. 4. The Middle Ware Server 18c comprises data collected from external systems of the service company. A sample middle ware server used by a service company comprises of the Human Resources Office Software 40a, Paypro Accounting Software 40b, Pace Infotrust Systems 40c and Elearn Online Training 40d. Web Interfaces such as Evaluation 42a and Sales 42b are also used to collect data through the Internet in the event that no external systems exist and saved directly into the criteria database of evaluation table 36d, and sales table 36f.

The Middle Ware Server 18c pulls electronic data 48 directly from the HR Office Database 40a, Paypro Database 40b and Elearn Database 40d, then restructures 44 this data into entity relationship tables 36 to be save3d in the criteria database 36. The criteria database 36 is an example of an entity relationship table where the employee 38a, store 38d and period 38c is connected to each of the six criteria tables: budget 36a, attendance 36b, performance 36c, evaluation 36d, training 36e and sales 36f. These criteria tables hold the subcriteria values for the system. The Middle Ware Server process synchronizes 44 with the employee 38a, store 38b, period 38c, budget 36a, training 36e and sales 36f tables of the criteria database 36. Individual text files from each individual's handheld units are uploaded from the Pace System 40c into the Middle Ware Server 18c. These text files are restructured and formatted 44 to be accrued into the criteria database 36 of the employee 38a, store 38b, period 38c, attendance 36b and performance 36c tables.

This invention relates generally to finding a mix of criteria parameters that affect the criteria of sales. The flow diagram FIG. 3A illustrates the criteria correlation process 120 for assigning the significance value to each correlation relationship. First, the system searches through the criteria database 36 for a relationship between a mix of subcriteria and sales 122 for the current period and the previous period in time. A period of time is defined by the administrator, e.g., two weeks. Relationships are labeled indirect 122a, direct 122b, and no change 122c. Direct relationships 122b refer to patterns where an increase in subcriteria values and an increase in sales, or the opposite are noted. Indirect relationships 122a refer to patterns where a decrease in subcriteria values and an increase in sales, or the opposite are noted. No change relationships 122c refer to patterns where no change in subcriteria values and no change in sales are noted. The relationship occurrence 124 of that subcriteria or mix of subcriteria is calculated by the system as a sum of the maximum of the occurrence of the direct 122b and indirect relationship 122a and the occurrence of no change relationship 122c. The significance of this relationship 126 is then calculated as the relationship occurrence divided by the total number of employees in the current period.

FIG. 3B illustrates the process of assigning weights for each sub criteria 130. Each subcriteria has a number, weight, assigned to it to specify the significance of this subcriteria in respect to the other subcriteria. The significance of each relationship 132 containing the subcriteria is summed 134 and divided 136 by the total sum of all relationships to arrive at the proposed weight for each subcriteria 138. The administrator has the option to adjust the weights of the subcriteria based on this proposed weight at the end of each period.

FIG. 4 illustrates the process of Correlation Pattern Search 140 in the criteria database 36. A pattern is specified as either a relationship described in 120 or as specific subcriteria values label associated with the sales. The subcriteria value is assigned five levels of significance; above target, on target, average, below target, way below target. The database server 28 searches through the criteria database for new patterns that exists in the current period and historical period 144 with significance level greater than the preferred level as specified by the administrator. Each of these pattern searches is saved 144 to the correlation table 32a. When the user communicates with the server system 18, the database server processes this 28 and generates a report 148 for the user to label each pattern of significance 150. These labels and patterns are saved 152 into the saved correlation table 32b. The user also have the ability to label actions 154 of each pattern and save into the action table 156 for the user to track the results of a certain pattern given a certain action.

The flow diagrams of FIGS. 2A-C illustrate the rating process 30c of the database server 28 using the data in the criteria database 36. For each period in time, the database server performs a routine rating calculation for each employee per subcriteria 90. The subcriteria data input 92 for employee is passed through the rating generator 94, where the output 96 of this performance rating is saved 98 to the rating database 34. The performance rating of this subcriteria along with all other subcriteria 102 for this employee are used as inputs for the performance rating overall generator 104 for that employee, where this 106 is also saved 108 in the rating database 34. The performance rating overall 112 for each employee is further used to calculate 114 the PRO for a specific group 116 and saved 118 to the rating database 34.

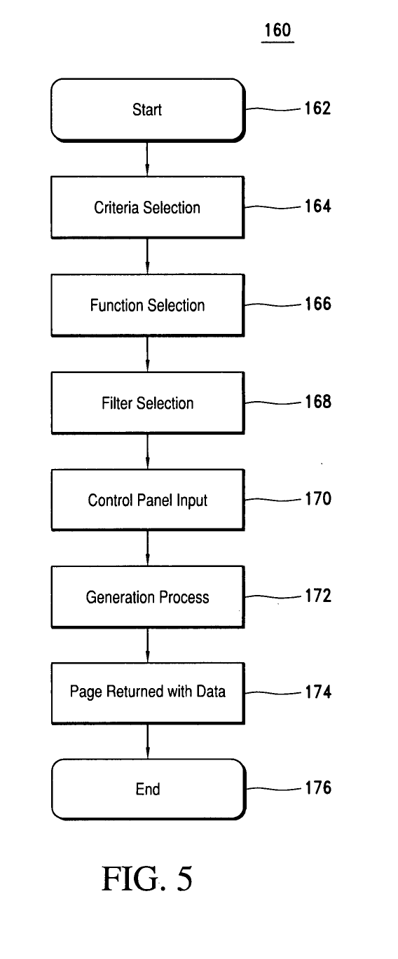

In the flow diagram of FIG. 5, the programming for the client system 10 and the server system 18 permits the user to set up a communication session between the client system 10 and the server system 18, whereby the user can communicate with the server system 18 to preview the data stored and processed in the database server 18b by selecting the criteria 164, selecting the function 166, selecting the employee filters 168 and controlling the input for each function 170 as input 22 to the database server 18b. Using this data input 22 communicated between the client and the server system 18, the database server 28 queries the data warehouse database 26c for data output 24 to be passed through the communication link.

The Performance Rating System is implemented on the server system 18 to provide an overall rating and an accurate assessment of criteria that contributes to store sales and to a successful employee. The six criteria included in overall rating measurement and predetermined to impact sales are Budget, Attendance, Performance, Evaluation, Training and Sales. This yield of correlation is achieved by the system from automatic pattern searches through the main database server for a similarity between criteria parameters and store sales or performance ratings overalls. System accuracy and effectiveness improves over time as more historical data and management labels are associated with these patterns. Flexible administrative functions allow security profiles to be created for each group or individual and modifications of system parameters. Search navigation on web interface allows the user to filter each function page of Map, Rating, Data, Report and Search based on system, criteria, time range and drill down parameters. This system comprises three mail database servers to handle the data from system processes, usage cases and data from external systems.

The Performance Rating System (PRS) is a tool designed to measure the Performance Rating Overall (PRO) of an employee or Store Over All Rating (SOAR) by determining the mix of criteria that impact sales. The Overall Scores for both employee and store are calculated by dividing the sum of the products between weights of relevance and the criteria rating with the sum of weights.

Six criteria with weights assigned to indicate relevance of Budget, Attendance, Performance, Evaluation, Training and Sales were predetermined to impact sales. The Budget criteria measures the performance rating of an employee based on the employee's cost of supplies/tools, worker's compensation, expenses, salary and bonus. The Attendance criteria measure the performance rating of an employee based on the unpaid absence and over time/under time. Managers are further measured based on the turnover rate of their employees: average length of service, average length of vacancy in position, voluntary/involuntary terminations and actual/intended headcount. The Performance criteria measures the performance rating of the employee's performance on the cross merchandise action plan (CMAP), class sheet, product knowledge (PK), merchandise action plan (MAP), special project (SP) and service compliance (SCS). The Evaluation criteria measures the performance rating of the employee based on the following managerial reviews: Literature Ordering System (LOS), Manager's Performance Evaluation, FSR/Store Walk, and Return to Vendor (RTV). The Training criteria measures the performance rating of the online training courses; this includes in store, regional and company training. The sales criteria measures the performance rating of the store based on sales and comp store sales.

Pattern correlation is used by this system to identify the mix of criteria that impact sales. The system searches through parameter values for a pattern that leads to a specific behavior. The number of times this pattern appears for individual increases the correlation factor of this pattern for the individual, service area, region and/or company. Once this pattern is recognized, the Management team is able to place a label for this correlation pattern. If action is required to repair a problem, then this will be recorded and the system will monitor the effects of this action and recognize this pattern in the future. This system allows Management to identify, track and fix issues that decrease sales as well as identify the necessary components that increases sales. The effectiveness of such a system increases over time when more data is used to train the system. As the system identifies the criteria of relevance that impact sales over time, the criteria weights are adjusted for a more accurate measurement of employee and store.

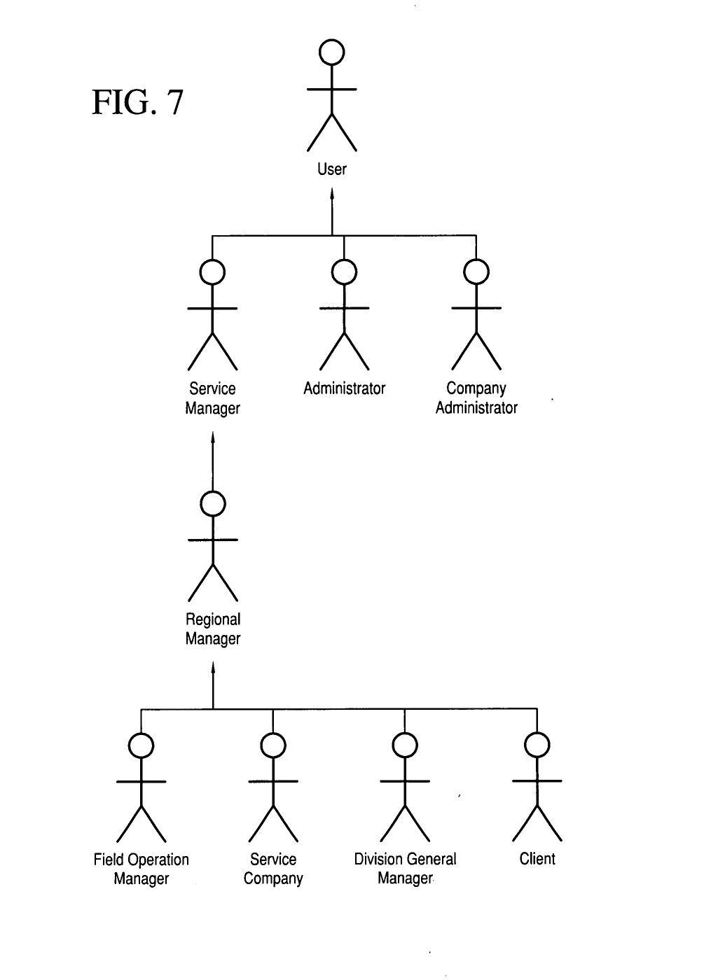

The administrator has the ability to create profiles and maintain system parameters. The Service company and the Client both have different Administrators to manage that section of the system. Generic profiles are created for each of the following: General User, Manager, and Higher Management; where the administrator can also create a single user or modify individual attributes. The diagram in FIG. 7 shows the user on the top with basic privileges, and the profiles below have additional privileges added. (See the list of profiles below).

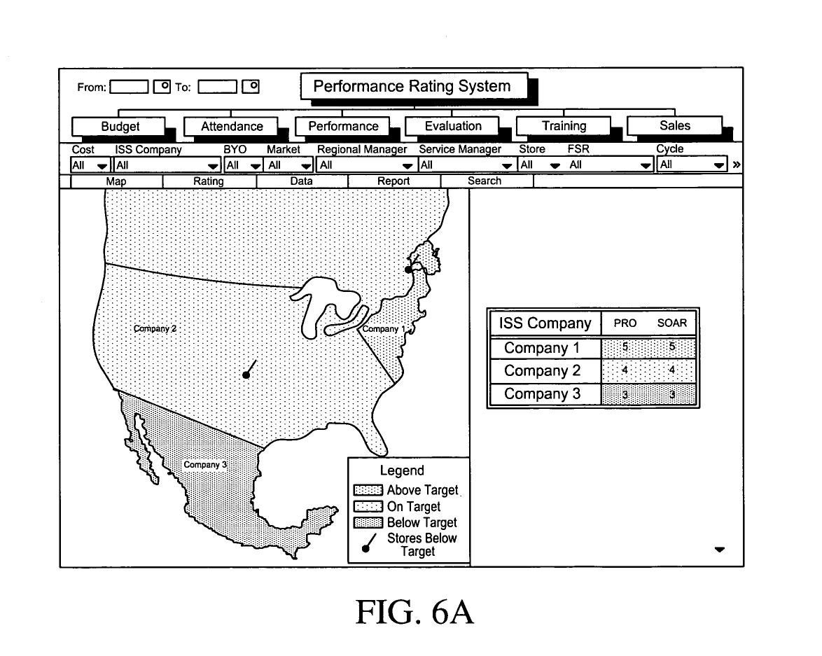

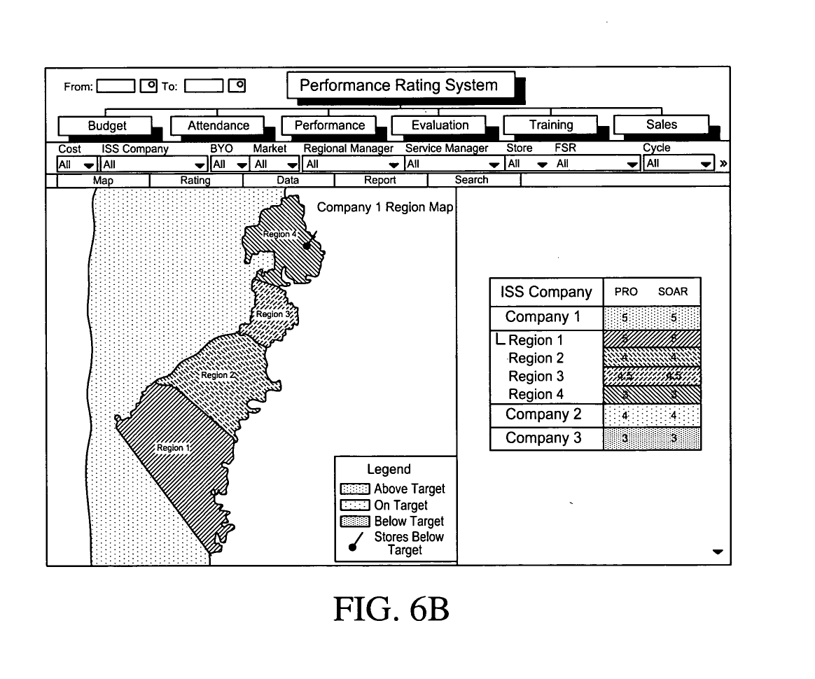

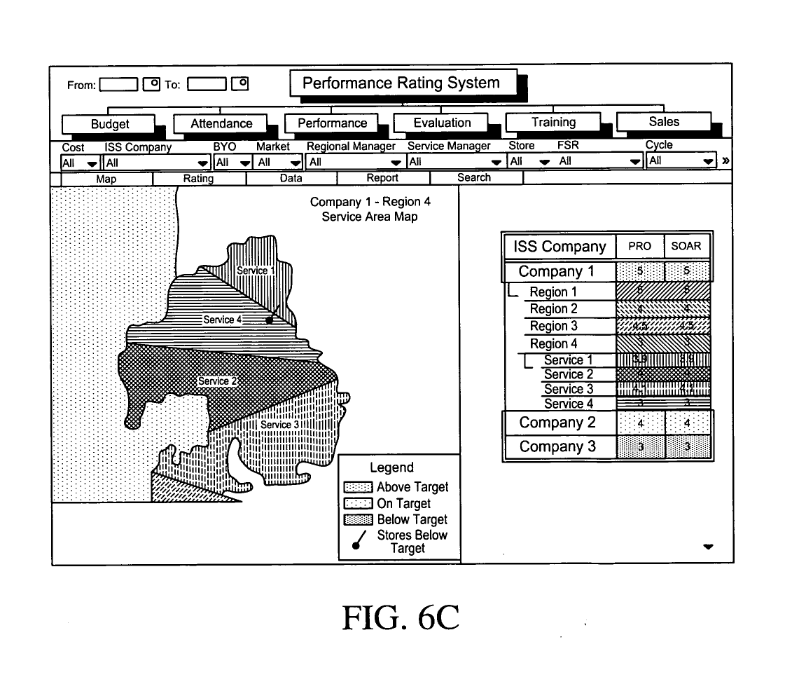

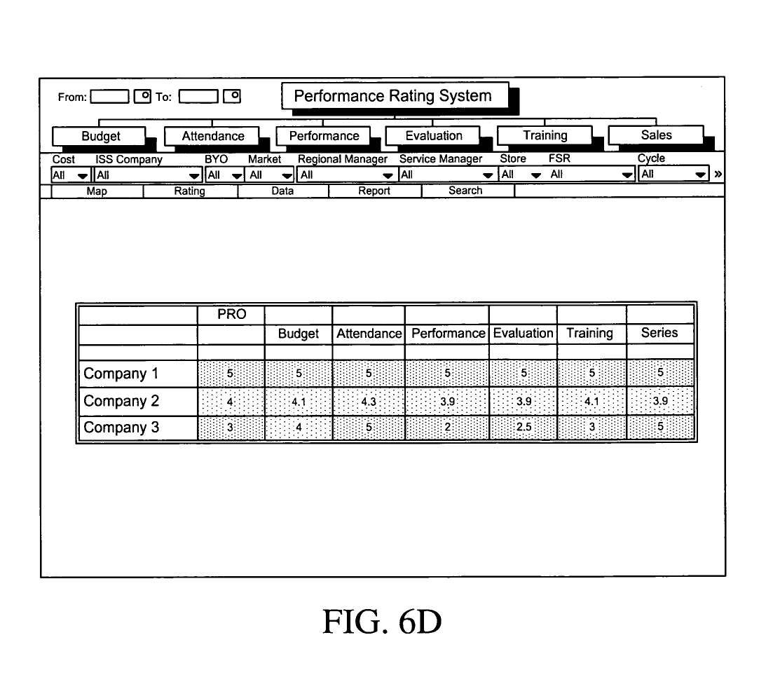

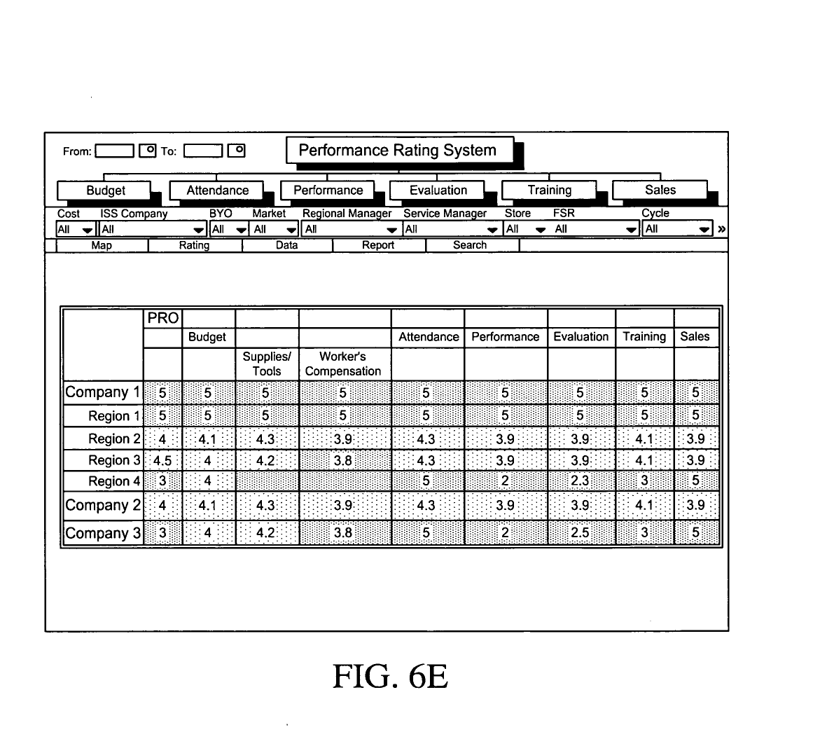

The web interface of this system is divided into several navigational bars for better access of the functionalities. These navigation bars allow the user to select the criteria and their parameters, drill down filters, time ranges and functions. The top navigation bar allows user to select the PRS System or each criteria and their parameters. The second navigation bar allows user to select from Department, Company, Region, Service Area and Store or Field Service Representative. The third navigation bar comprises the start and end time in which the data is representing. The fourth navigation bar allows user to select the type of function page to display. An illustrative color rating system of red, green and yellow identifies the groups that are performing below target, on target and above target. (See FIGS. 6A, 6B, 6CF, 6D and 6E illustrating the Map Representations).

The five main functions of this system are: Map, Rating, Data, Report and Search. Based on the selections of the first three navigation bars, the data or rating is displayed on these function Figures. The Map function displays the performance rating on a map for immediate warning of which areas need improvement. This map is similar to a weather map displaying different colors in performance offering different layers for each criteria for direct comparison of companies or areas. The rating function displays the performance rating overall and store overall rating. The Data function displays the parameter values in which each criteria is based upon. The Report function shows the system analysis of a specific recognized pattern as well as predefined reports based on the data. The Search function allows Managers to view and label unidentified patterns with high correlation as well as to search the data for relevant reports to save. (See FIGS. 6A, 6B, 6C, 6D and 6E show the Map Representation).

The PRS Data system comprises of three main data servers: the Database Server, the Web Server and The Middleware Server for system processing, user interaction and data processing from other systems. The database server comprises of three main databases: the system databased, data warehouse, and map database. The System Database comprises of management of user profiles, configurations and system parameters. The Data Warehouse Database restructures the data from our Middleware server for a more efficient system and holds data for system search of pattern correlation. The Map database stores the maps and the many layers needed for the system to display information. PRS Web server maintains all the user interfaces needed for PRS System and is able to manage petitions from Pocket PC interfaces through Web Services. PRS Middleware Server pulls data from external systems that the service company might be using. For example, every company might be using a different Human Resources Database to hold their employee information. This middleware server contains connectors to these external databases and offers companies the alternative of web interfaces to enter this information directly to this server in the event that an external system does not exist. (See FIG. 1: Data Server Model).

The following description shows the conditions and equations for calculation of the overall rating of employee and store. The performance rating of each criteria, PR at criteria I has a rating scale of 0-Rₙ. A coefficient, W, is given to each criteria i or sub-criteria j to signify the weight of that criteria compared with the other criteria. The number of criteria, C, and sub-criteria, S, are used for the equations below. The conditions are that the sum of the weights of the criteria can not be more than 1. The sum of the weights of sub-criteria can not be more than the weight of criteria i. The performance rating for each criteria is calculated by dividing the summation of the products of weights and rating of sub-criteria with the summation of weights for criteria i (EQN 1).

Common Terms:

| | |
|---|---|
| PR(i) = | Performance Rating criteria i |
| Rₙ = | Rating Number; where the maximum number of our rating sale, |
| | R is a constant |
| PRO = | Overall Performance Rating |
| W(i) = | Weight for criteria I |
| C | Total number of criteria |
| W(j) = | Weight for criteria s |
| S = | Total number of sub-criteria |

Conditions

1. Sum of Weights for all criteria cannot be more than 1.

$${\sum }_{i = 1 , C}^{i} W ( i ) <= 1$$

2. Sum of Weights for all Sub-Criteria for Criteria i Cannot be More than Weight of Criteria i.

$${\sum }_{j = 1 , S}^{j} W ( j ) <= W ( i )$$

EQN 1. Performance Rating for Each Criteria (I)

$$PR ( i ) = {\sum }_{j = 1 , S}^{j} [ W ( j ) * PR ( j ) ] / {\sum }_{j = 1 , S}^{j} W ( j )$$

The performance rating overall, PRO, of each field service representative (FSR) is calculated by dividing the sum of the products of the weight, W(i), and performance rating for the employee, PR(i) of each criteria, I, with the summation of weights to provide the overall performance rating (See EQN 1a). The PRO for the Service Company, market, and region or service area is calculated by the average of the PRO of all field service representatives in the specified location for the department (See EQN 1b). The PRO is calculated every cycle, of ten working days as defined by client.
EON 1a. Performance Rating Overall for Field Service Representatives (FSR)

$$PRO ( FSR ) = {\sum }_{i = 1 , C}^{i} [ W ( i ) * PR ( i ) ] / {\sum }_{i = 1 , C}^{i} W ( i )$$

EQN 1b. Performance Rating Overall for Service Companies (ISS)
PRO(ISS)=Avg[PRO(FSR in ISS company)]
PRO(Market=Avg[PRO(FSR in Market)]
PRO(Region)=Avg[PRO(FSR)in Region)]
PRO(Service Area)=Avg[PRO(FSR in Service Area)]

The Store OverAll Rating, SOAR, of each store is calculated by dividing the sum of the products of the weight, W(i), and performance rating, PR(i) of each criteria for the store, I, with the summation of weights to provide the overall performance rating (See EQN 1c). The SOAR for the Service Company, market, region or service area is calculated by the average of the SOAR of all stores in the specified location for the department (See EQN 1d). The SOAR is calculated every cycle, of ten working days as defined by client.
EQN 1c. Store Overall Rating

$$SOAR ( StoreID ) = {\sum }_{i = 1 , C}^{i} [ W ( i ) * PR ( i ) ] / {\sum }_{i = 1 , C}^{i} W ( i )$$

EQN 1d. Store Overall Rating for Service Companies (ISS)
SOAR(ISS)=Avg[SOAR(Stores in ISS company)]
SOAR(Market)=AVG[SOAR(Stores in Market)]
SOAR(Region)=Avg[SOAR(Stores in Region)]
SOAR(Service Area)=Avg[SOAR(Stores in Service Area)]

Below is a list of the different profiles created for the Service company or the Client Company. (See FIG. 7)

User is a general user and only has the ability to log on into the system.

Administrator has the ability to change weights of criteria that make up the overall performance rating, sales rating and color rating of map and store interface. They can also change the rating scale number. They also have the ability to change how often a Manager's evaluation and LOS evaluation has to be submitted for an employee. They also have the ability to grant access to companies.

Client has the ability to view overall performance ratings of all service groups on the United States Map and table interface.

Service Companies have the ability to view the overall performance ratings of their company's region by regional managers, service managers and field service representatives.

Company Administrator has the ability to grant users and administer their privileges.

Division General Manager and higher positions have the ability to view the overall performance ratings and individual criteria ratings of all regions in the company on the Map and table interface. They have the ability to view the breakdown in performance rating of their company by regional managers, service managers and field service representatives. They also be able to view the weight of the criteria and the factors that influence the criteria. They are also able to view the employee and store rating page.

Field Operational Manager have the ability to view the overall performance ratings and individual criteria ratings of all regions in the company on the Map and table interface. They also have the ability to view the breakdown in performance rating of their company by regional managers, service managers and field service representatives.

Regional Manager have the ability to view the overall performance ratings and individual criteria ratings of all regions in the company on the Map and table interface. However, they only have the ability to view the breakdown in performance rating of their region by service managers and field service representatives.

Service Manager have the ability in this illustrative embodiment to view the overall performance ratings and individual criteria ratings of all the service areas in their region on the Map and table interface. However, they only have the ability to view the breakdown in performance rating of their region by field service representatives.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention.

Benefits, other advantages, objects, and solutions to problems have been described above with regard to specific embodiments. However, the benefits, advantages, solutions to problems, objects, and any element(s) that may cause any benefit, advantage, or solution to occur or become more pronounced are not to be construed as a critical, required, or essential feature or element of any or all of the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

I claim:

1. A method implemented by a programmed computer of determining the performance of at least one person to carry out at least one activity, the activity comprises a plurality of tasks, said method comprises the steps of:
a) determining from a plurality of tasks at least one task to be performed by one person;
b) defining at least one set of criteria, each criteria determines how well the one person performs a corresponding task;
c) defining for each task a weight that determines the relative effectiveness of its criteria to enhance the performance of the activity;
d) measuring a numerical rating reflective of how well the activity corresponding to each of the plurality of criteria is being performed;
e) multiplying the numerical rating reference for each of the plurality of criteria times the corresponding weight to provide a product related to the corresponding criteria;
f) summing the products related to each of the plurality of criteria to provide a total of the products of all of the criteria; and
g) dividing the total of the products by the sum of the weights to provide an overall rating that is reflective of the performance ranking of the one person to carry out the activity.
